(19) United States
(12) Patent Application Publication
(10) Pub. No.: US 2012/0174149 A1
(43) Pub. Date: Jul. 5, 2012

(54) PROVIDING ADVERTISING CONTENT TO A USER

(76) Inventors: Jennifer Reynolds, Johns Creek, GA (US); Paul Canter, Gainesville, GA (US); Charles Dasher, Lawrenceville, GA (US); Dheeraj Ravula, Roswell, GA (US)

(21) Appl. No.: 12/981,818

(22) Filed: Dec. 30, 2010

(51) Int. Cl. H04N 7/167; H04N 7/025

(52) U.S. Cl. 725/31; 725/32

(57) ABSTRACT

Advertising content is provided to a user. A set top box that is located in a first environment receives a first signal from a user device located in the first environment, wherein the first signal is encoded with commerce-related information. The set top box conveys the commerce-related information via a digital communication network to a server system located in a second environment. The server system utilizes the commerce-related information to select advertising information pertaining to the commerce-related information, and then communicates the advertising information to a device from which the user of the user device located in the first environment can access the advertising information.

### BACKGROUND

The invention relates to technological mechanisms for providing advertising content to a user, and more particularly to technological mechanisms for providing advertising content to a user wherein the advertising content is known to be of relevance to the user.

Providers of advertising content have long used traditional communication media (e.g., print media such as newspapers and magazines, and electronic media such as radio and television commercials) to reach potential customers in the hopes of influencing the recipients of the advertising content to act in a certain manner (e.g., to purchase a particular product). A traditional way of increasing the effectiveness of any particular advertising campaign is simply to present the advertising content to as many people as possible. The effectiveness of this strategy relies on the advertising content being relevant to only a fraction of the population that receives it. Assuming that the fraction remains constant, increasing the absolute number of people who are swayed by the advertising content is achievable by increasing the size of the recipient population.

The inventors of the subject matter described herein have recognized that traditional techniques for providing advertising content are at best inefficient. Furthermore, as technological advances create more and more media outlets for users to select from (e.g., hundreds of possible cable television channels, many thousands of potential websites for Internet users to select from), it is increasingly impractical to reach a wider audience.

The inventors of the subject matter described herein have accordingly recognized that another way of increasing the effectiveness of advertising content is to present it in an intelligent manner that targets the audience for whom the content has some particular relevance.

For example, in an increasingly connected world it is expected that common household devices will be more aware of their functions and communicate with a variety of other household devices. As one example, prototype refrigerators (e.g., Smart Fridge) have the ability to be aware of their contents and display recommended recipes based on them. Purely conceptual refrigerators (e.g., self-replenishing refrigerators) are evidence of an increasing desire on the part of both consumers and manufacturers to act in accordance with a “connected everything” paradigm, in which household devices are aware of their status.

Prototypes and conceptual work based on the “connected everything” paradigm have shown how such connection can provide direct benefits to consumers (e.g., by automatically ordering groceries, repair work, or generating recipes). But to date, little if any attention has been paid to providing mechanisms that allow manufacturers to capitalize on the “connected” household devices, particularly with respect to influencing which goods or services are purchased.

It is therefore desirable to provide technology that utilizes one or more “connected” household devices to facilitate a manufacturer's ability to influence a consumer's selection of goods or services.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods, systems, and apparatuses for providing advertising content to a user comprising. This involves a set top box that is located in a first environment receiving a first signal from a user device located in the first environment, wherein the first signal is encoded with commerce-related information. The set top box conveys the commerce-related information (e.g., alternatively encrypted or non-encrypted) via a digital communication network to a server system located in a second environment. The server system utilizes the commerce-related information to select advertising information pertaining to the commerce-related information, and communicates the advertising information to a device from which the user of the user device located in the first environment can access the advertising information.

In some but not all embodiments, the device from which the user of the user device located in the first environment can access the advertising information is the set top box. In such embodiments, there are a number of possible additional features that may be present in some but not necessarily all embodiments. For example, the user device located in the first environment can be a household device capable of detecting a commerce-related situation, and generating the commerce-related information from the detected situation. The household device can be, for example, a refrigerator that is capable of detecting a need for one or more grocery items. The advertising information in such embodiments can comprise an advertisement relating to the one or more grocery items.

Another possible additional feature in such embodiments, involves the advertising information comprising an advertisement to be displayed on a video device connected to the set top box.

In alternative ones of some but not necessarily all embodiments, the device from which the user of the user device located in the first environment can access the advertising information is a server that is accessible by the user of the user device. For example, server can be an e-mail server that houses an e-mail account of the user of the user device. In some alternative embodiments, the server can be a server that supplies a feed to one or more subscribers. In yet other alternative embodiments, the server can be a server that sends the advertising information as a push message to a mobile communications device associated with the user of the user device. In another aspect of some but not necessarily all of such embodiments, the user device is a set-top box remote control device, and the commerce-related information is usable as an indicator (e.g., reminder) of an advertisement that was playing on a video device connected to the set-top box when a switch on the remote control device was activated.

### BRIEF DESCRIPTION OF THE DRAWINGS

The objects and advantages of the invention will be understood by reading the following detailed description in conjunction with the drawings in which:

FIG. 1 is, in one respect, a flow diagram of steps/processes performed by technological means for providing advertising content to a consumer in accordance with some aspects of embodiments consistent with the invention.

FIG. 2 is a block diagram of an exemplary embodiment that assumes the presence of a set top box capable of engaging in bidirectional communications with a communications network.

FIG. 3 is a combination block/flow diagram of an exemplary one of a number of embodiments consistent with the invention.

FIG. 4 is, in one respect, a flow diagram of steps/processes performed by technological means for providing advertising content in a group of embodiments consistent with some aspects of the invention.

FIG. 5 is a combination block/flow diagram of an exemplary alternative one of a number of embodiments consistent with the invention.

FIG. 6 is, in one respect, a flow diagram of steps/processes performed by technological means for providing advertising content in a group of alternative embodiments consistent with some aspects of the invention.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors). Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

The inventors of the subject matter described herein have recognized a number of deficiencies, from a manufacturer's point of view, with respect to the utilization of connected household devices for the purpose of influencing a consumer's selection of goods or services. For example, as mentioned in the Background section, there exist prototypes and conceptual work on devices that are aware of their status and are able to make automatic responses based on that status such as by automatically ordering groceries, repair work, and the like. However, conventional approaches do not take into account the traditional ways that consumers have of purchasing items or ordering repairs. Consumers may have brand preferences but nonetheless enjoy and exercise the ability to freely choose the goods or services that they will actually purchase. If this were not the case, advertisements would be pointless. But automated solutions that always reorder the same brand of the item whenever it is detected that the item needs to be replenished do not provide an opportunity for the consumer to try a different brand when the order is placed.

Additionally, such automatic ordering of goods and services would leave the manufacturers out of the loop as well, without any means for marketing their goods or services to a consumer who is increasingly locked into brand preferences. Advertisements would become less valuable, and industries that rely on those advertisements for income (e.g., cable media communication industries) would become victims as well.

The inventors of the subject matter described herein have further recognized that advertisers often try to make their products or services memorable to a viewer in a variety of ways. Nonetheless, advertisers struggle with the relative lack of consumer attention paid to advertisements compared to the attention paid to the television program being watched. This disparity often results in consumers forgetting advertisements for goods or services that they are actually interested in, thereby representing a lost opportunity.

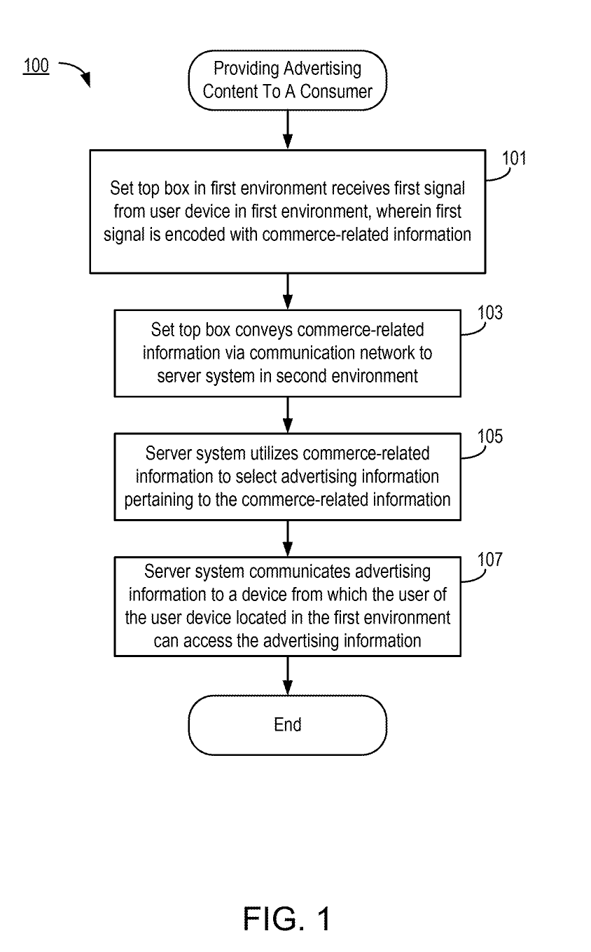

Technological mechanisms involving one or more household devices can be utilized to address one or more of the above-described problems. Aspects of embodiments consistent with the invention will now be described with reference to FIG. 1 which is, in one respect, a flow diagram of steps/processes performed by technological means for providing advertising content to a consumer. In another respect, FIG. 1 can be considered to depict means 100 for providing advertising content to a consumer, the means 100 itself comprising the variously illustrated means for performing the described functions.

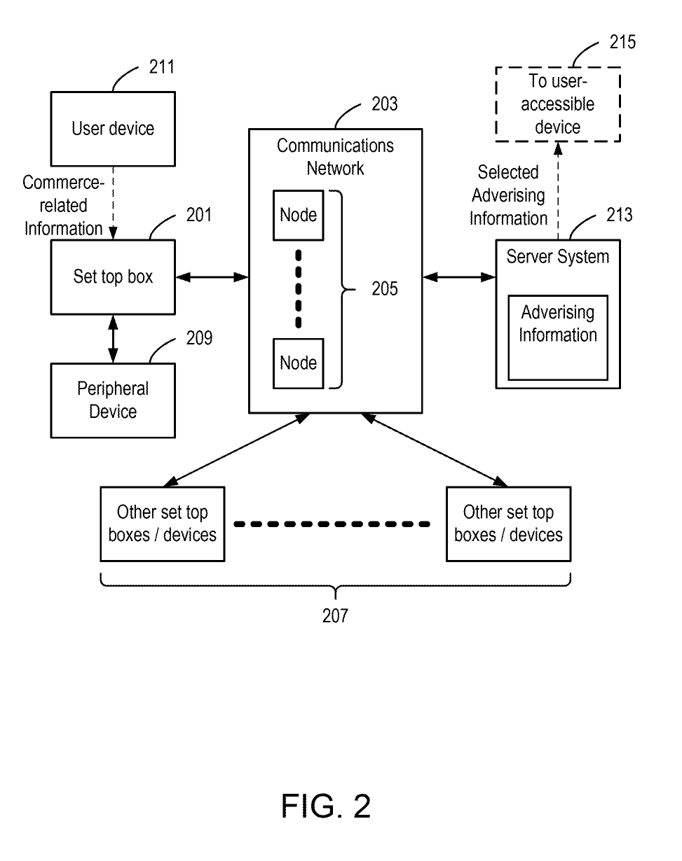

In this illustrated embodiment, reference is made to a “first environment”. The first environment may be, for example, a user's home but this should be understood to represent merely a non-limiting example since the particular nature of the first environment is not an essential aspect of the invention. To facilitate the reader's understanding of the described aspects, FIG. 2 is a block diagram of an exemplary embodiment that assumes the presence of a set top box 201 capable of engaging in bidirectional communications with a communications network 203. The communications network 203 can comprise any number of nodes 205, as is well known in the art, and can be coupled to any number of other set top boxes/devices 207, the presence of which is not pertinent to the invention. The set top box 201 can further be connected to a peripheral device 209 in the first environment, such as but not limited to video equipment, the peripheral device 209 being for the purpose of presenting program content to the user. The program content in such embodiments is provided by means of the communications network 203 to the set top box 201, which generates suitable signals therefrom for presenting the program content on the attached peripheral device 209. It should be understood that the term “set top box”, as used herein, is to be construed broadly to include similar devices that do not necessarily present video content to a user. Other components illustrated in FIG. 2 are a user device 211 located in the first environment, a server 213, and a path from the server 213 to a user-accessible device 215. The user device is able to send a signal to the set top box 201 by any means (e.g., wired or wireless). The server 213 and the set top box 201 are able to carry on bidirectional communications via the communications network 203. In practical embodiments, the server 213 is typically not located in the same “first environment” as the set top box 201, although in theory there is no reason why it could not be. The server 213 is further capable of sending information to a user-accessible device 215, either through the communications network 203 or by other means. The nature of the user-accessible device 215 may vary between embodiments, as will be illustrated below.

Exemplary functions performed by the components illustrated in FIG. 2 will now be described with reference to FIG. 1. In an aspect of embodiments consistent with the invention, the set top box 201 receives a first signal from a user device 211 also located in the first environment, wherein the first signal is encoded with commerce-related information (step 101). The set top box 201 conveys the commerce-related information via the communication network 203 to a server system 213 located in a second environment (step 103).

The server system 213 utilizes the commerce-related information to select advertising information pertaining to the commerce-related information (step 105) and then communicates the selected advertising information to a device that is accessible to the user of the user device 211 (step 107).

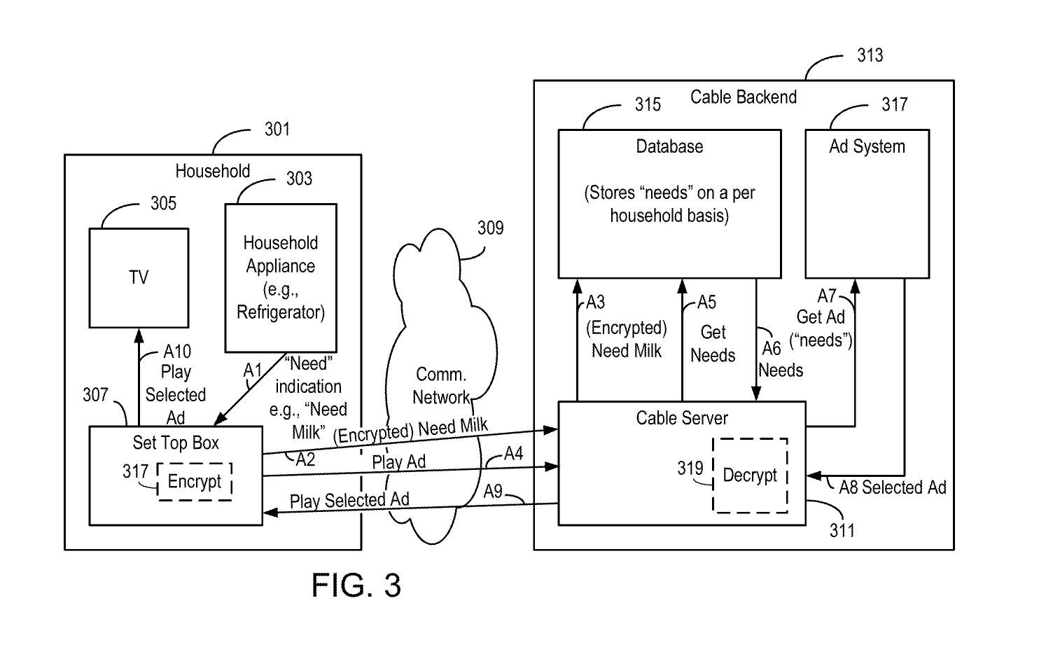

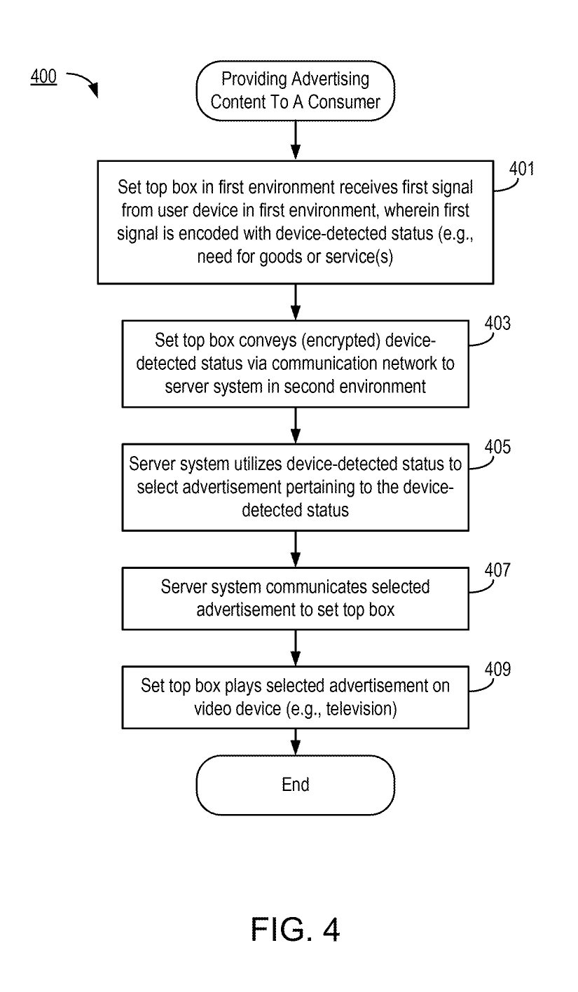

The principles presented above can be employed in many different alternative embodiments. A combination block/flow diagram of one such embodiment is presented in FIG. 3. Consistent embodiments are also illustrated in FIG. 4 which is, in one respect, a flow diagram of steps/processes performed by technological means for providing advertising content to a consumer. In another respect, FIG. 4 can be considered to depict means 400 for providing advertising content to a consumer, the means 400 itself comprising the variously illustrated means for performing the described functions.

Embodiments illustrated by FIGS. 3 and 4 are useful when it is desired to present advertising information to a user, wherein the advertising information is particularly selected because of its relationship to some need of the user (e.g., a needed service or goods). The user's household 301 serves as a first environment that includes one or more household appliances (represented in this embodiment by the household appliance 303). The household 301 also includes a television (“TV”) 305 that receives cable or satellite programming by means of a connection (wired or wireless) to a set top box 307. The set top box 307 includes some form of processing circuitry (e.g., a programmable processor and a memory having stored therein one or more sets of program instnictions) for carrying out at least the various functions described herein.

The set top box 307 is coupled through a communications network 309 to a cable server 311 located in a cable backend environment 313 which, in this embodiment, constitutes a second environment. Such connections, as well as mechanisms whereby a cable server provides program content to a set top box, are well known in the art and need not be described herein in detail.

Of relevance to this particular embodiment is the fact that the cable backend environment 313 further includes a database 315 that provides for storage and retrieval of information as will be described in further detail below, and an ad system 317 that, as will be described in further detail below, constitutes means for providing advertising content that is selected as a function of “needs” information. As used herein, the term “needs” is used to denote any status detected by the household appliance 303 and communicated to the set-top box 307. For example, and without limitation, when the household appliance 303 is a refrigerator, the “needs” information might denote the status “needs milk”.

In brief, the strategy that is adopted is one in which any arbitrary device communicates wirelessly (through any known protocol) with household cable (or equivalent) equipment represented by the set top box 307. The connected household device then transmits messages regarding its status to the cable (or satellite, or IP TV, or equivalent) equipment. The content of these messages is stored at the cable head end. When video on demand (VOD) advertisements (or any other form of individualized ads) are selected for this household, the selecting mechanism is informed of the status of the household's devices. Selection of the advertisement is then made as a function of the provided status information. For example, if a house is out of milk, more advertisements relating to milk are played, which serves the dual purpose of making the viewer aware of the need for milk (direct consumer benefit), while simultaneously allowing manufacturers to compete with respect to which brand of milk the viewer will choose to purchase. Another example is a household with an aging computer. As a result of the strategy adopted in this embodiment, users in that household would see more computer ads. It is advantageous, although not essential to the invention, for the status information to be communicated and stored in an encrypted form, thereby maintaining privacy as may be required in accordance with any existing governmental laws or standards.

Turning now to the embodiment depicted in FIG. 3 and the more generic ones depicted in FIG. 4, the household appliance 303 (in this example a refrigerator) detects a need for one or more particular products, represented in this example by milk, and communicates a signal to the set top box 307 (step A1, 401). The signal communicated to the set-top box 307 is encoded with a “need” indication (e.g., a need for particular goods or service(s)) corresponding to the device-detected status (e.g., “needs milk”).

A nonlimiting example of a wireless signal (in this case XML-like) that can be communicated to the set-top box 307 is:

<device>

<device_type = “fridge”>
<status = “needs milk”>
<status = “needs cheese”>
<status = “past manufacturer's warranty”>

</device>

In some but not necessarily all embodiments, the set top box's processing circuitry includes encrypting means 319. The encrypting means 319 can be embodied in any number of ways, such as and without limitation, dedicated hardwired circuitry or encryption software comprising instructions that control the operation of a programmable processor. The set top box 307 forms a signal representing the “need” indication and communicates this signal (in some embodiments in encrypted form) via the communication network 309 to the cable server 311 located in the cable backend environment 313 (steps A2, 403).

The timing of steps A1 and A2 can vary from one embodiment to another. For example, these steps can be performed whenever there is a status change detected by the household appliance 303. In alternative embodiments, detected changes in status can be accumulated and stored in the household appliance 303 and then communicated in aggregate to the set top box 307 at predetermined times or events (e.g., at midnight). In yet other alternative embodiments, changes in status can be communicated to the set top box 307 as soon as they are detected by the household appliance 303, and the set top box 307 can accumulate and store the accumulated “need” information so that it can be communicated to the cable server 311 at predetermined times or events (e.g., at midnight). The particular timing of this communication is not an essential aspect of the invention, and other alternatives are readily derivable from the information presented herein.

In most cases, the cable server's receipt of the “need” information will not be coincident with the need to play an advertisement to the user. To accommodate this situation, the cable server 311 stores the “need” information into the database 315 in a manner that associates the “need” information with this particular household 301 (step A3). If the “need” information was received in an encrypted form, it should also be stored in this encrypted form to preserve to security and confidentiality of the information.

At some point in time, the system detects that an advertisement should be presented to the user within the household 301. For example, it may be detected that the user has initiated the start of VOD programming In such cases, advertising information can be presented to the user just prior to presentation of the user's selected programming Other scenarios are conceivable, and all are amenable to conformance in accordance with the principles described herein.

Having detected that it is time to present advertising information to the user, the server system utilizes the device-detected status to select an advertisement pertaining to the device-detected status (step 405). In this exemplary embodiment, this involves the cable server 311 accessing the database 315 in order to retrieve the “need” information from the database 315 (step A5). The database 315 locates the requested “need” information and supplies this to the cable server 311 (step A6).

In embodiments in which the “need” information is in encrypted form, the cable server 311 is advantageously equipped with decrypting means 321 which, like the encrypting means 319, can be embodied in any number of ways, such as and without limitation, dedicated hardwired circuitry or encryption software comprising instructions that control the operation of a programmable processor. The encrypting means 319 and the decrypting means 321 can be adapted to use symmetrical keys or alternatively to use asymmetrical keys. The type of key used for encryption/decryption is not an essential aspect of the invention. It is sufficient that the decrypting means 321 should be capable of decrypting information that has been encrypted by the encrypting means 319.

The “need” information, as part of a request to retrieve an advertisement, is supplied by the cable server 311 to the ad system 317 (step A7). The ad system 317 selects an advertisement as a function of the “need” information, and returns this to the cable server 311 (step A8). The cable server 311 communicates the selected advertisement through the communications network 309 to the user's set top box 307 (step A9, 407). The set top box 307 then presents the selected advertisement to a peripheral device (e.g., in this example a television 305) (step A10, 409).

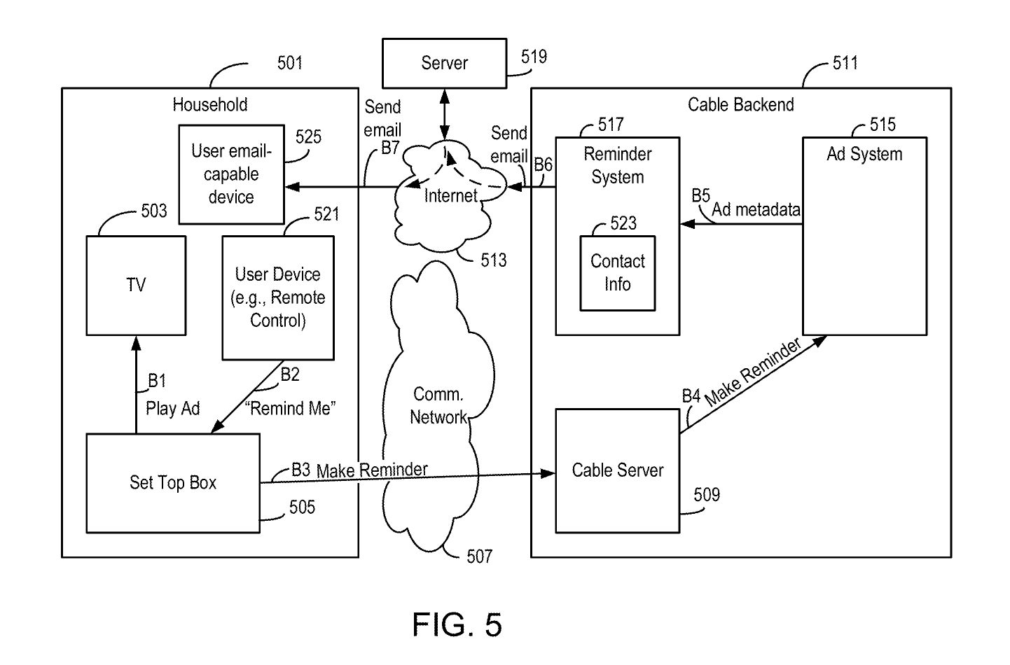

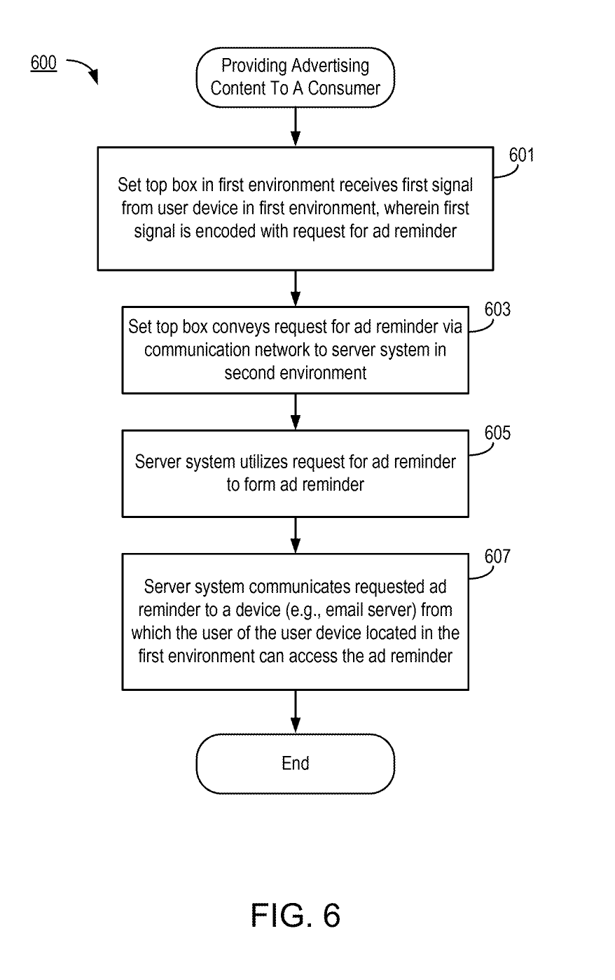

A combination block/flow diagram of another one of many possible embodiments is presented in FIG. 5. Consistent embodiments are also illustrated in FIG. 6 which is, in one respect, a flow diagram of steps/processes performed by technological means for providing advertising content to a consumer. In another respect, FIG. 6 can be considered to depict means 600 for providing advertising content to a consumer, the means 600 itself comprising the variously illustrated means for performing the described functions.

Embodiments illustrated by FIGS. 5 and 6 are useful when it is desired to present advertising information to a user, wherein the advertising information is a reminder of a previously advertised service or product that the user had expressed an interest in. The user's household 501 serves as a first environment that includes a television 503 that receives cable or satellite programming by means of a connection (wired or wireless) to a set top box 505. The set top box 505 includes some form of processing circuitry (e.g., a programmable processor and the memory having stored therein one or more sets of program instructions) for carrying out at least the various functions described herein.

The set top box 505 is coupled through a communications network 507 to a cable server 509 located in a cable backend environment 511 which, in this embodiment, constitutes a second environment. Such connections, as well as mechanisms whereby a cable server provides program content to a set top box, are well known in the art and need not be described herein in detail. The communications network 507 may be dedicated or public, and may or may not include access to the Internet 513. In order to facilitate this description, the communications network 507 and the Internet 513 are depicted as being separate entities, but this need not be the case in all embodiments.

Of relevance to this particular embodiment is the fact that the cable backend environment 511 further includes an ad system 317 that, as will be described in further detail below, constitutes means for providing information about advertising reminder content that is selected as a function of control signals supplied by the cable server 509. The cable backend environment 511 further includes a reminder system 517 that constitutes means for appropriately formatting an advertising reminder for a user and sending the advertising reminder to a destination known to be associated with the user. This may include a path through a server 519 associated with the user, such as but not limited to an e-mail server that functionally supports an e-mail account of the user, or some type of push server that is capable of sending the advertising reminder to a device associated with the user without the user having first taken steps to retrieve the particular advertising reminder from the push server. For example, the user may have a device (e.g., a mobile device such as a cell phone) configured as a subscriber to a feed that is functionally supported by the server 519. When the server 519 receives updated information (e.g., the advertising reminder), the updated information is automatically communicated to the user's device.

The strategy that is adopted in this set of embodiments is one in which a user experiences (e.g., sees, hears) an advertisement by means of a home device, such as a television 503 (step B1). If the user is interested in the advertised service or product, he or she activates a switch on a user device 521 (e.g., a “remind me” button on a remote control device). Activation of the switch on the user device 521 causes the user device 521 to communicate a signal to the set top box 505, wherein the signal is encoded with a request for an advertising reminder (step B2, 601).

The set top box 505 responds by conveying the request for an ad reminder via the communication network 507 to the cable server 509 in the cable backend environment 511 (step B3, 603). The cable server 509, or alternatively the ad system 515, is aware of which advertisement is playing at what time. The cable backend environment 511 therefore utilizes the request for the ad reminder to form an advertising reminder (step 605). In the exemplary embodiment of FIG. 5, this involves the cable server 509 forming a signal representing sufficient information to identify the user and which advertisement was playing when the user activated the switch on the user device 521 (step B4). The ad system 515 selects ad metadata from a collection of stored ad metadata, wherein the selection is made as a function of the information contained in the signal supplied by the cable server 509. The ad metadata includes appropriate information for the anticipated means of communication. For example, if the advertising reminder is to be made available to the user by means of an e-mail message, the ad metadata could contain a subject header, and a body comprising text and/or other information describing the advertisement that the user wishes to be reminded about (e.g., “Three Day Sale at Big Store” accompanied by a link to the Big Store's website).

The selected ad metadata is supplied to a reminder system 517 (step B5). The reminder system 517 has access to contact information 523 from which it obtains the needed contact information (e.g., an email address) to send the advertising reminder to the user. In some but not necessarily all embodiments, the contact information 523 may be a billing system that is alternatively included within or separate from the reminder system 517. The location of the contact information 523 is not an essential aspect of the invention; it is sufficient that the reminder system 517 be able to access the contact information 523 and retrieve the necessary information.

After forming the advertising reminder (e.g., an e-mail message), the reminder system sends it to a device (e.g., a server 519) from which the user of the user device 521 can access the advertising reminder (step B6, 607).

The mechanism by which the user is able to receive the advertising reminder can vary from one embodiment to another. For example, when the advertising reminder is in the form of an e-mail that had been sent to an e-mail server 519, the user can view it at his or her leisure by means of any user e-mail-capable device 525 (e.g., a computer or a mobile Internet-capable device) (step B7).

In yet another aspect of embodiments consistent with the invention, features illustrated in FIGS. 3-6 can be employed together such that the advertisement played on the user's television 305, 503 is one that has been selected for that particular user based upon “need” information supplied by a household appliance 303, and wherein the user, being particularly interested in the selected advertisement, activates the user device 521 so that he or she will later receive an advertising reminder that can be viewed/played on a suitable device associated with the user (e.g., a user e-mail-capable device 525). In this way, the features illustrated in FIGS. 3-6 are used in tandem.

Various embodiments consistent with the invention provide one or more advantages over conventional systems. Allowing television advertisements to be informed by a consumer's actual needs (e.g., as detected by a household appliance 303) allows advertisers to advertise products more efficiently (i.e., there is no need to waste money trying to sell a car to a consumer who has just purchased a new one) and also allows consumers to be aware of their needs as they arise.

Television operators benefit in that their place in an increasingly connected world is made more secure and their advertising revenue remains relevant.

Advertisers can also benefit by being provided a way for those viewers who are truly interested in the advertiser's product to have an automatic follow-up reminder of an advertisement. With such a reminder, viewers are less likely to forget their interest and are more likely to purchase the product.

Advertisers can additionally benefit from there being a simple, automatic way for them to track user interest in a particular advertising campaign, since any user who requests a reminder is likely to have been enthused by the advertisement.

Viewers can also benefit in that they are provided a simple, familiar interface (e.g., their remote control device) with which to remember things that align with their interests and goals. Viewers can save money by remembering sales more easily and are relieved of having to divide their attention between the television and non-television note taking devices (e.g., pen and paper, smart phone, etc).

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of providing advertising content to a user comprising:
a set top box that is located in a first environment receiving a first signal from a user device located in the first environment, wherein the first signal is encoded with commerce-related information;
the set top box conveying the commerce-related information via a digital communication network to a server system located in a second environment;
the server system utilizing the commerce-related information to select advertising information pertaining to the commerce-related information; and
the server system communicating the advertising information to a device from which the user of the user device located in the first environment can access the advertising information.

2. The method of claim 1, wherein the device from which the user of the user device located in the first environment can access the advertising information is the set top box.

3. The method of claim 2, wherein the user device located in the first environment is a household device capable of detecting a commerce-related situation, and generating from said detection the commerce-related information.

4. The method of claim 3 wherein the household device is a refrigerator that is capable of detecting a need for one or more grocery items.

5. The method of claim 4, wherein the advertising information comprises an advertisement relating to the one or more grocery items.

6. The method of claim 2, wherein the advertising information comprises an advertisement to be displayed on a video device connected to the set top box.

7. The method of claim 2, wherein the commerce-related information is encrypted prior to being communicated to the server system located in the second environment.

8. The method of claim 1, wherein the device from which the user of the user device located in the first environment can access the advertising information is a server that is accessible by the user of the user device.

9. The method of claim 8, wherein the device from which the user of the user device located in the first environment can access the advertising information is an e-mail server that houses an e-mail account of the user of the user device.

10. The method of claim 8, wherein the device from which the user of the user device located in the first environment can access the advertising information is a server that supplies a feed to one or more subscribers.

11. The method of claim 8, wherein the server sends the advertising information as a push message to a mobile communications device associated with the user of the user device.

12. The method of claim 8, wherein the user device is a set-top box remote control device, and wherein the commerce-related information is usable as an indicator of an advertisement that was playing on a video device connected to the set-top box when a switch on the remote control device was activated.

13. A system for providing advertising content to a user comprising:
a set top box that is located in a first environment; and
a server system located in a second environment,
wherein the set top box comprises:
circuitry configured to receive a first signal from a user device located in the first environment, wherein the first signal is encoded with commerce-related information; and
circuitry configured to convey the commerce-related information via a digital communication network to a server system located in a second environment;
and wherein the server system comprises:
circuitry configured to utilize the commerce-related information to select advertising information pertaining to the commerce-related information; and
circuitry configured to communicate the advertising information to a device from which the user of the user device located in the first environment can access the advertising information.

14. The system of claim 13, wherein the device from which the user of the user device located in the first environment can access the advertising information is the set top box.

15. The system of claim 14, wherein the user device located in the first environment is a household device capable of detecting a commerce-related situation, and generating from said detection the commerce-related information.

16. The system of claim 15, wherein the household device is a refrigerator that is capable of detecting a need for one or more grocery items.

17. The system of claim 16, wherein the advertising information comprises an advertisement relating to the one or more grocery items.

18. The system of claim 14, wherein the advertising information comprises an advertisement to be displayed on a video device connected to the set top box.

19. The system of claim 14, wherein the set top box comprises encrypting means for encrypting the commerce-related information prior to the commerce-related information being communicated to the server system located in the second environment.

20. The system of claim 13, wherein the device from which the user of the user device located in the first environment can access the advertising information is a server that is accessible by the user of the user device.

21. The system of claim 20, wherein the device from which the user of the user device located in the first environment can access the advertising information is an e-mail server that houses an e-mail account of the user of the user device.

22. The system of claim 20 wherein the device from which the user of the user device located in the first environment can access the advertising information is a server that supplies a feed to one or more subscribers.

23. The system of claim 20, wherein the server comprises circuitry configured to send the advertising information as a push message to a mobile communications device associated with the user of the user device.

24. The system of claim 20, wherein the user device is a set-top box remote control device, and wherein the commerce-related information is usable as an indicator of an advertisement that was playing on a video device connected to the set-top box when a switch on the remote control device was activated.

25. A method of providing advertising content to a user comprising:
a server system in a second environment receiving commerce-related information from a set top box located in a first environment;
the server system utilizing the commerce-related information to select advertising information pertaining to the commerce-related information; and
the server system communicating the advertising information to a device from which the user of the user device located in the first environment can access the advertising information.

26. A server system for providing advertising content to a user comprising, wherein the user has access to a set top box located in a first environment and the server system is located in a second environment, the server system comprising:
circuitry configured to receive commerce-related information from the set top box by means of a communications network;
circuitry configured to utilize the commerce-related information to select advertising information pertaining to the commerce-related information; and
circuitry configured to communicate the advertising information to a device from which the user of the user device located in the first environment can access the advertising information.
